(19) United States
(12) Patent Application Publication
(10) Pub. No.: US 2010/0037168 A1
(43) Pub. Date: Feb. 11, 2010

(54) SYSTEMS AND METHODS FOR WEBPAGE DESIGN

(76) Inventors: Nile Thayne, Salt Lake City, UT (US); Gregory M. Tracey, Cottonwood Heights, UT (US); Jarad L. Hull, Lehi, UT (US)

Correspondence Address: David B. Tingey, 1800 Eagle Gate Tower, 60 East South Temple, Salt Lake City, UT, 84145, US

(21) Appl. No.: 12/501,055

(22) Filed: Jul. 10, 2009

Related U.S. Application Data
(60) Provisional application No. 61/079,769, filed on Jul. 10, 2008.

(51) Int. Cl. G06F 3/048

(52) U.S. Cl. 715/769

(57) ABSTRACT

Systems and methods for providing a design interface that allows a user to design a webpage through a drag-and-drop method are described. In some cases, the interface allows the user to place content within the webpage using an absolute positioning technique. In such a technique, the user can place content in any position in the webpage, including overlapping other content, and the interface will automatically update the positioning data into the webpage's definition files. Additionally, in some cases, the interface automatically pushes content to a server in near real time. While in some instances the design interface is client-based, in preferred instances, the design interface is network based.

### RELATED APPLICATIONS

This application claims priority to United States Provisional Patent Application Ser. No. 61/079,769, filed Jul. 10, 2008, entitled, “SYSTEMS AND METHODS FOR WEBPAGE DESIGN,” which is incorporated herein by reference.

### BACKGROUND OF THE INVENTION

1. Field of the Invention

The present invention relates to webpage design. More particularly, the present invention relates to systems and methods for providing a computer-based (e.g., network- or client-based) interface that allows a user to design a webpage through a drag-and-drop technique that automatically updates one or more webpage definition files and optionally pushes updated definition file or files to a server in near real time.

2. Background and Related Art

A webpage is a medium for communication and is accessible over of a network, such as the World Wide Web. Webpages are used to provide information, advertising, entertainment, social interaction, educational information, purchase opportunities, and a variety of other types of information and interactive opportunities. Indeed, many have found webpages to be a powerful tool for a variety of activities. As a result, the need and desire for webpages is growing at an astonishing rate.

Currently, webpages are designed in a variety of ways. In some instances, a user designs a webpage through the use of a text editor. In such instances, the user can directly enter code and design the webpage by using a design language, such as HTML, XHTML, PHP, DHTML, XML, XSL, JAVASCRIPT, ECMASCRIPT, and/or another similar markup or script language. In other instances, the user utilizes webpage editing software, such as an HTML editor, to design a webpage. In such instances, the user can design a webpage by directly entering content into the editor. Additionally, in such instances, the webpage editing software may automatically convert some of the user's commands into a design code that defines the characteristics of the webpage.

However, many current methods of webpage design have shortcomings. By way of example, most, if not all, webpage design methods require that the user who designs the page have at least some understanding of design coding and design languages. In some instances, this requirement prevents people from designing a webpage well or at all. Additionally, this required understanding of design coding and languages forces many to hire webpage designers to build desired webpages.

Although some webpage editing software may reduce the amount of understanding the user needs to design a webpage, such software is not without its shortcomings. For example, some editing software still requires the user to understand some design language or coding. For instance, some software requires the user to design a cascading style sheet (“CSS”), or to be bound to a template (e.g., a CSS or markup page defining tables, spacers, fonts, coloring, container positioning, and/or other layout information) that provides the layout, typographic, and/or color scheme of the user's webpage. Along these lines, some editing software binds the user to place content in defined tables or containers within a template page or to manually redesign the CSS or template to place content, such as picture, in a different location within the page. Similarly, many forms of editing software do not allow the user to easily layer and overlap content. As a result, many users are prevented from building a webpage with the appearance they desire.

In another example of the limits of editing software, some editing software requires the user to push changes to webpage content to a network (e.g., via a file transfer protocol (“FTP”)) before the changes can be seen from the network. Because many users are unfamiliar with such file transfers, this requirement can prevent some users from designing a webpage or may be bothersome during webpage design.

Thus, while techniques currently exist that are used to design webpages, challenges still exist, including those previously mentioned. Accordingly, it would be an improvement in the art to augment or even replace current methods and techniques with other methods or techniques.

### SUMMARY OF THE INVENTION

The present invention relates to webpage design. More particularly, the present invention relates to systems and methods for providing a computer-based (e.g., network- or client-based) interface that allows the user to design a webpage through a drag-and-drop technique that automatically updates a webpage definition file and optionally pushes the updated definition file to a server in near real time. In some cases, the design interface comprises an edit mode, which displays a header section and a production environment section.

The header section can include any component suitable for use with the webpage design interface, including one or more tool bars (e.g., an editing toolbar, a drawing toolbar, a formatting toolbar, etc.), drop-down menus (e.g., a file menu, an edit menu, a tool menu, a view menu, etc.), buttons (e.g., bold, underline, highlight, etc.), spinners, sliders, ribbons, and so forth. In some cases, however, the header section comprises one or more graphic user interface (“GUI”) content widget icons (“widget icons”). The header section can comprise widget icons for any suitable content that can be displayed on a webpage. For instance, the header section can comprise widget icons that are designed for images, text, audio, video, chat forums, instant messaging forums, etc. Generally, these widgets icons can be dragged from the header section, into the production environment, where they expand to a content widget (“widget”) that is configured to display one or more specific types of content on the webpage.

In addition to displaying content, each widget can be modified to include any suitable widget configuration information (e.g., size limits, widget category description, and/or other defining characteristics, such as opacity, border style, background color, size, three-dimensional position, etc.).

Generally, the production environment section displays a view of the webpage being built. In fact, in some cases, the production environment displays the webpage in substantially the same manner in which it would appear over a network at any given moment. While the production environment can comprise any component suitable for use with the webpage design interface, in some cases, the production environment comprises an optional grid system that aids in aligning widgets or other elements within the webpage.

In the edit mode, the design interface can have a variety of features and capabilities. In one example, the design interface allows the widget icons from the header section to be dragged and dropped as widgets in any location on the production environment. Indeed, unlike many other web design software applications that require content to be placed in tables or containers with pre-defined positions, the described design interface offers an easy and flexible method for content placement. Additionally, in this example, as the user places a widget within the production environment, the design interface performs an absolute positioning technique in which the user is allowed to place a widget in any location in the production and environment and in which an absolute position of the widget is automatically entered into one or more of the webpage's definition files (e.g., one or more CSS files, configuration files, XML definition files, and/or similar files). For instance, where the webpage comprises a CSS file and where movement of a widget changes the webpage's layout, the design interface automatically updates the webpage's CSS, in the background and without the user ever needing to see the CSS file.

In another example of a feature of the design interface, the interface allows widgets to be layered on and to overreach other widgets within the production environment. While this layering can be performed in any suitable manner, in some cases, it is performed by providing each widget with a Z order and placing the widget with the higher Z order over the widget with the lower Z order.

In still another example, the design interface automatically pushes content and changes to a server in near real time. While this function can be performed in any suitable manner, in some cases, it is performed by making an asynchronous JavaScript and XML (“AJAX”) request on the server for each edit action made by the user.

While the methods and processes of the present invention have proven to be particularly useful for designing webpages, those skilled in the art can appreciate that various aspects of the described methods and processes can be used in a variety of different applications and in a variety of different areas. For example, aspects of the described webpage design interface can be used in a variety of visual design software applications, such as software applications for creating blog sites; editing pictures, text, images; and similar applications.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use with the present invention;

FIG. 2 illustrates a representative networking system that provides a suitable environment for use with some embodiments of the present invention;

FIG. 3 illustrates a representative embodiment of a webpage design interface;

FIGS. 4A-4C illustrate screenshots of representative embodiments of the described webpage design interface;

FIG. 5 illustrates a flow chart showing a representative embodiment of a method for designing a webpage by using the described design interface; and

FIGS. 6-8 illustrate screenshots of some representative embodiments of the described design interface.

### DETAILED DESCRIPTION OF THE INVENTION

The present invention relates to webpage design. More particularly, the present invention relates to systems and methods for providing a computer-based (e.g., network- or client-based) interface that allows the user to design a webpage through a drag-and-drop technique that automatically updates one or more webpage definition files and optionally pushes the updated definition file or files to a server in near real time.

The following disclosure of the present invention is grouped into two subheadings, namely “Representative Operating Environment” and “Webpage Design Interface.” The utilization of the subheadings is for convenience only and is not to be construed as limiting in any sense.

### Representative Operating Environment

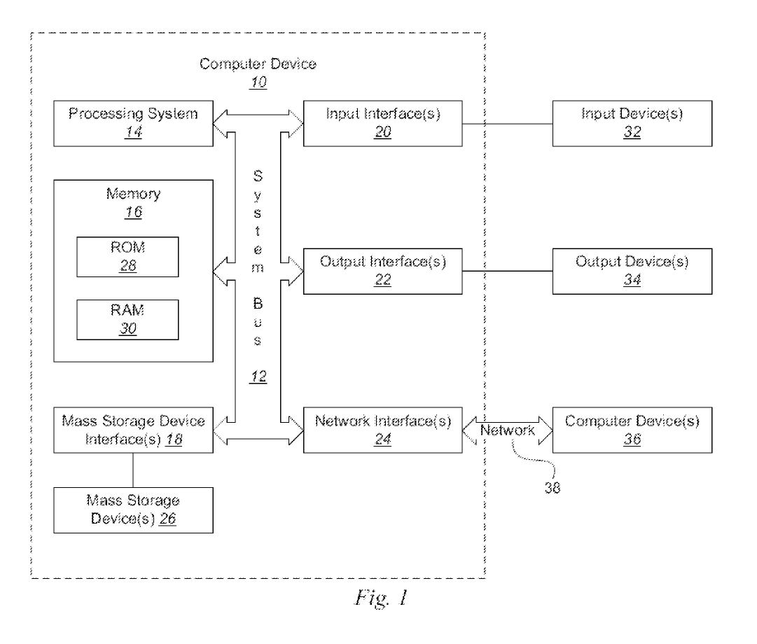

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a tablet computer, a personal digital assistant (“PDA”), or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable the user to enter data and/or instructions to computer device 10 through one or more corresponding input devices 32. Examples of such input devices include a microphone, a joystick, a game pad, a game controller, a satellite dish, a scanner, a camcorder, a digital camera, an audio recorder, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a speaker, a printer, a visually perceptible output device (e.g., a monitor, display screen, or any other suitable visualization device), and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

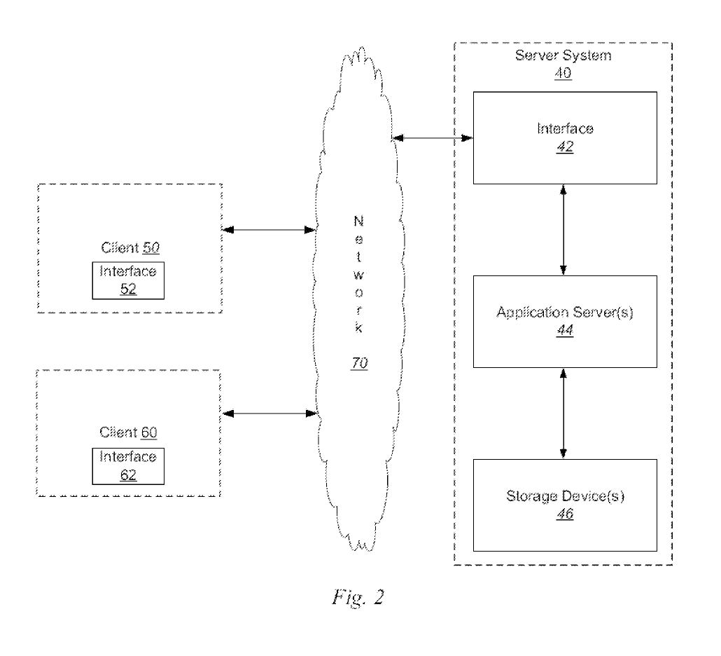

While those skilled in the art will appreciate that the invention may be practiced in networked computing environments with many types of computer system configurations, FIG. 2 represents an embodiment of the present invention in a networked environment that includes clients 50 and 60 connected to a server system 40 via a network 70. While FIG. 2 illustrates an embodiment that includes two clients connected to the network 70, alternative embodiments include one client connected to a network or many clients connected to a network. Moreover, embodiments in accordance with the present invention also include a multitude of clients throughout the world connected to a network, where the network is a wide area network, such as the Internet.

### Webpage Design Interface

The present invention relates to webpage design. More particularly, the present invention relates to systems and methods for providing a computer-based (e.g., network- or client-based) interface that allows the user to design a webpage through a drag-and-drop technique that automatically updates one or more of a webpage's definition files in near real time. In some embodiments, the design interface also automatically pushes the updated definition file or files to a server in near real time. While the described design interface can be client-based and run on an individual client, in some preferred embodiments, the design interface is network-based (e.g., web-based). In such embodiments where the design interface is network-based, the interface is run on a network server, which a client computer can access via a Web browser (e.g., INTERNET EXPLORER®, FIREFOX®, OPERA®, or another suitable Web browser).

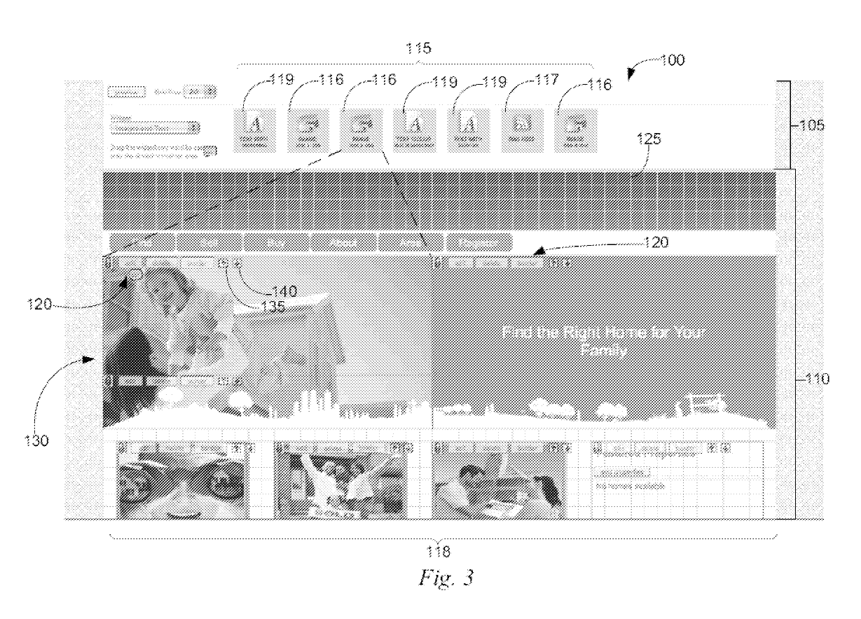

In some embodiments, the design interface comprises an edit mode in which the user can view, create, and/or edit a webpage. The edit mode can act as a GUI that displays the Webpage that is being built/edited as well as a variety of editing tools. While the screen display of the edit mode may be divided in any suitable manner, FIG. 3 show a representative embodiment in which the edit mode screen 100 comprises a header section 105 and a production environment section 110. Additionally, while the header section 105 can be located in a variety of positions with respect to the production environment 110, FIG. 3 shows an embodiment in which the header section 105 is located above the production environment 110. In another currently preferred embodiment, however, the header section overlaps the production environment and is configured to scroll with the production environment when the production environment is scrolled. To provide a better understanding of the edit mode, the header section and production environment are described below in more detail.

The header section can include any component suitable for use with the described webpage design interface. In one example, the header section includes one or more tool bars (e.g., an editing toolbar, a drawing toolbar, a formatting toolbar, etc.). In another example, the header section includes one or more drop-down menus (e.g., a file menu, an edit, a tool menu, a view menu, an insert menu, etc.). In yet another example, the header section comprises one or more buttons (e.g., a bold button, an underline button, a highlight button, etc.). In still another example, the header section comprises one or more sliders, list boxes, spinners, ribbons, combination boxes, etc.

In a final example, the header section comprises one or more widget icons and/or widgets. By way of illustration, FIG. 3 shows an embodiment in which the header section 105 comprises a plurality of widget icons 115. As used herein, the term widget icon, and variations thereof, may refer to any suitable icon that can be dragged from the header section into the production environment so that the icon is converted into a widget. As used herein, the term widget, and variations thereof, may refer to a visual building block that contains data to be processed by the design interface. With respect to the data that can be contained by a widget, a widget generally comprises any suitable type of content that can be displayed on the Web. Some non-limiting examples of such content include images (e.g., *.jpg, *.gif, *.bmp, *.tiff, *.png, etc.), videos, text, audio files (e.g., *.wav, *.mp3, etc.), documents (e.g., *.pdf, *.doc, *.wpd, etc.), metadata, headers, advertisements, links, RSS feeds, snippets of code to pull content from a third party site (e.g., live content), tables, containers, and so forth.

In another example of suitable data that can be contained in a widget, a widget can comprise display code, which includes a combination of PHP, JAVASCRIPT, HTML, and/or another suitable markup or scripting language that is capable of being used to display webpage content. In another example, a widget comprises editor information or information that identifies the specific content that will be displayed by a particular widget. This editor information may be particularly useful where a widget allows variable content to be displayed on the webpage. In still another example, a widget comprises configuration information, which provides a description of the widget, icons linked with the widget, size limits of the widget, widget category, etc. In still other embodiments, a widget contains information defining attributes of the widget, such as opacity, transparency, border type, background type or color, size, the two- or three-dimensional position of the widget, etc.

Generally, the production environment displays a view of the webpage being built. While, in some embodiments, the production environment displays the webpage in a manner that is substantially similar to the manner in which it would appear over a network at any given time, FIG. 3 shows that, in another embodiment, the production environment 110 displays the webpage 118 with variety of editing options 120 that are visible to the user but not to visitors of the webpage over the network.

While the production environment 110 can comprise any component suitable for use with the webpage design interface, FIG. 3 shows some embodiments where the production environment 110 comprises an optional grid system 125 that aids in aligning widgets or other elements within the webpage. In such embodiments, the grid system can be turned on or off and grid scaling can be adjusted as desired by the user. Additionally, while the grid lines can help the user manually align a widget with one or more gridlines, in some cases, the interface comprises a snap-to-grid feature in which a widget is automatically aligned with the intersecting gridlines that are closest to the widget when the widget is dropped in the production environment.

In the edit mode, the design interface can have a variety of features and capabilities. In one example, the design interface allows widget icons from the header section to be dragged and dropped into the production environment as widgets. By way of example, FIG. 3 shows the user may choose to grab a variety of widget icons 115 from the header section 105, including icons 116 for images of various sizes (e.g., 500×250 pixels, 200×200 pixels, etc.), an icon 117 for an RSS feed, and icons for various types of texts 119. While the widget icon can increase or decrease in size to form a widget that displays a specific type of content in the production environment, the dashed lines in FIG. 3 show that, in some embodiments, the widget icon 116 expands to a larger widget 130 when the icon 116 is placed in the production environment 110.

Unlike many other web design software applications that require content to be placed in defined tables, containers, or in locations that the user can only resize, move, and/or otherwise edit by manually changing one or more webpage definition files (e.g., a CSS file, a XML definition file, and/or a configuration file), the described design interface allows the user to place content-containing widgets in any location within the production environment simply by dragging and dropping a widget icon or widget in a desired location. For instance, instead of being forced to either place a picture in a pre-defined container position or to manually recode the container position, the user can simply drag a desired widget icon (e.g., for a picture) from the header section to a desired location on the production environment. Once the widget icon or widget is moved to the desired location, the user drops the widget icon or widget to place a widget in the webpage.

Similarly, the described interface allows the user to reposition, resize, and/or rotate widgets (e.g., a widget containing a YOUTUBE® video clip, a picture, a chat forum, a design, etc.) within the webpage by simply dragging the widgets or one of the widgets' comers from their original positions and dropping them in different positions. This ability to drag-and-drop widgets in any virtually any suitable location in the production environment is referred to herein as absolute positioning.

Additionally, unlike some web design applications that do not allow tables or containers to overlap, in some embodiments, the design interface allows the user to layer or overlap widgets. While this feature can be performed in any suitable manner, in some embodiments, it is performed by assigning each widget with a Z order and placing the widget with the higher Z order above a widget with a lower Z order. By way of illustration, FIG. 3 shows an embodiment in which a widget 130 comprises arrows 135 and 140. In this illustration, the user can increase the Z order of a widget 130 by selecting the up arrow 135 and decrease its Z order by selecting the down arrow 140.

As mentioned, unlike many web design applications that require the user to manually edit webpage definition files (e.g., one or more CSS files, XML files, configuration files, etc.) to effect certain changes to content and to the page layout, the described interface allows the user to edit the webpage by moving a variety of content types across the webpage without viewing one or more of the webpage's definition files. In some embodiments, the design interface automatically updates the webpage's definition files as the user edits the webpage (e.g., moves or edits widgets). Accordingly, the user can use the design interface to design a webpage and corresponding webpage definition files with little to no knowledge of design coding.

In some cases, the design interface automatically updates the webpage's definition files in near real time. For example, where the webpage includes a CSS file and the user makes changes to webpage that require the CSS file to be changed, the interface will automatically update the CSS file as the user makes the changes.

In some embodiments, the interface automatically creates a XML site definition as the user edits the webpage. In such embodiments, this definition can identify all content, pages, positioning, and other attributes needed to display the webpage. This definition can then allow for replication of the webpage from a design layout and provide the webpage with backup and library functions. Accordingly, this definition can allow the user to quickly proliferate pages having a similar appearance.

In another example of a feature of the design interface, in some embodiments, the interface automatically pushes each of the user's edits to the server in real time. Accordingly, the user's changes are immediately available on the network without requiring the user to take an extra step of pushing the content to the server (e.g., via an additional FTP step). While this automatic pushing function can be performed in any suitable manner, in some embodiments, the design interface performs this function by making an AJAX request on the server for reach edit action that is made by the user. For instance, with each of the user's edits, the interface may send an XML definition file of the webpage to a database and to a domain object model (“DOM”) for the webpage.

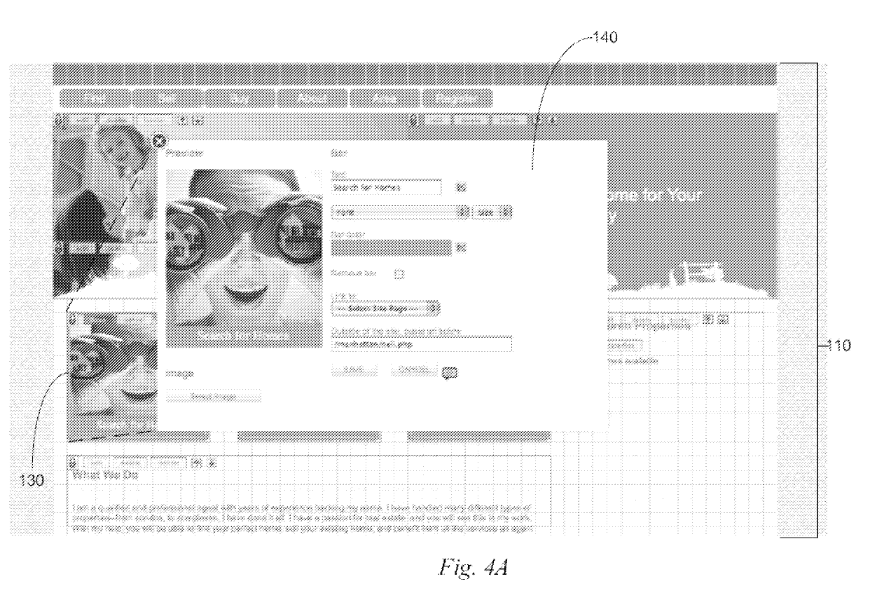

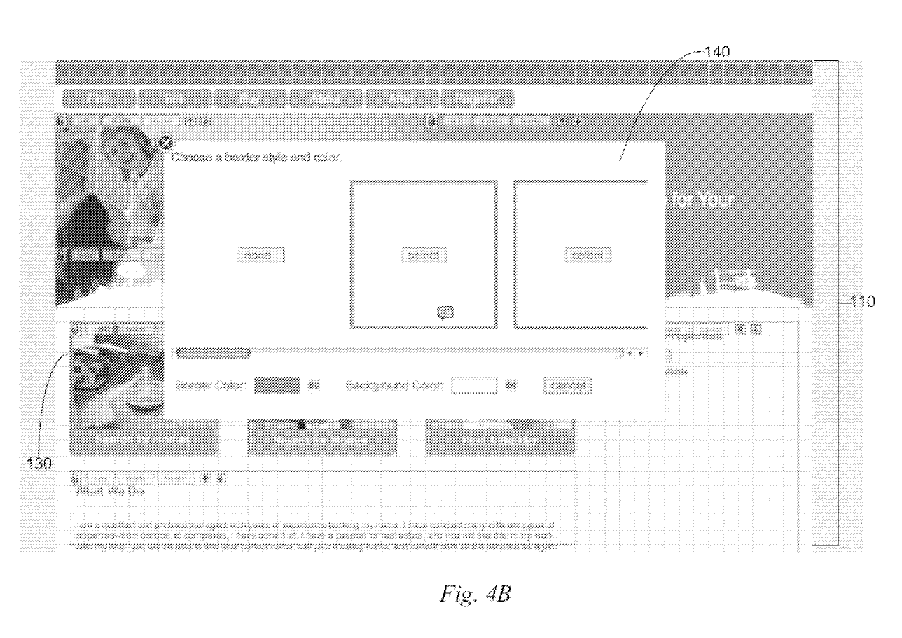

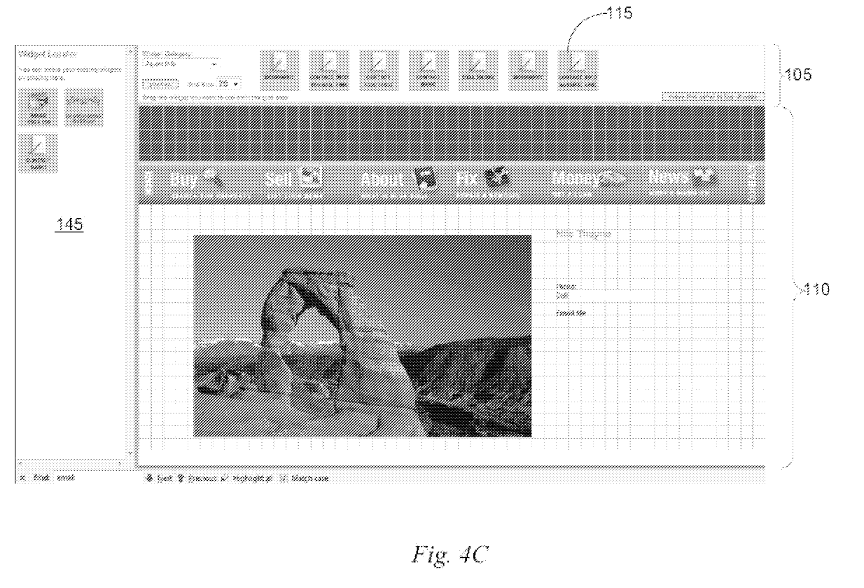

In addition to the aforementioned characteristics, the design interface may comprise any other suitable component or characteristic that allows it to function as intended. By way of example, FIG. 4A shows an embodiment in which each widget can be selected to access a widget edit window 140. In this example, each edit window may be used to edit a widget in any suitable manner. For instance, FIG. 4A shows that an edit window 140 can be used to edit a widget (e.g., widget 130) the use of fields (e.g., text, font, bar color, link to, select image, transparency level, etc.). Similarly, FIG. 4B shows an edit window that can be used to give or edit a border around a widget (e.g., widget 130).

In another example of an optional characteristic, FIG. 4C shows that, in some embodiments, the design interface comprises a listing 145 of widgets that have been placed in the production environment 110. While this widget listing may serve many purposes, in some instances, the widget listing allows the user to keep track of widgets in the production environment, even as the widgets are layered on top of each other and become blocked from the user's view.

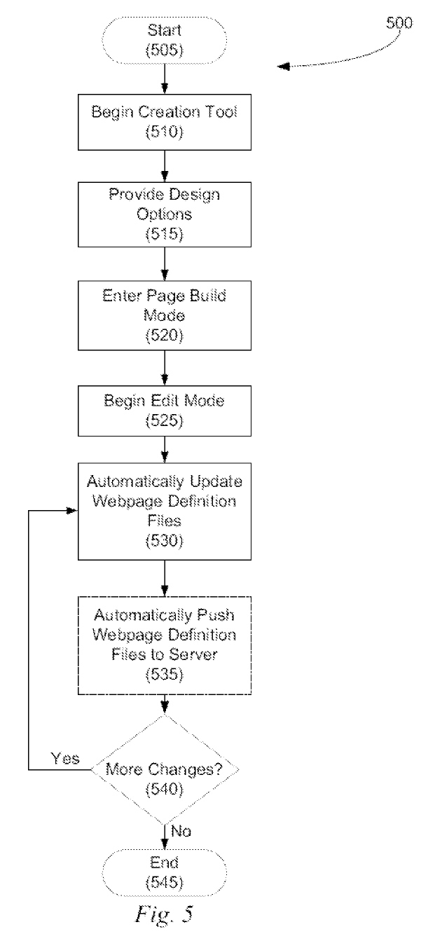

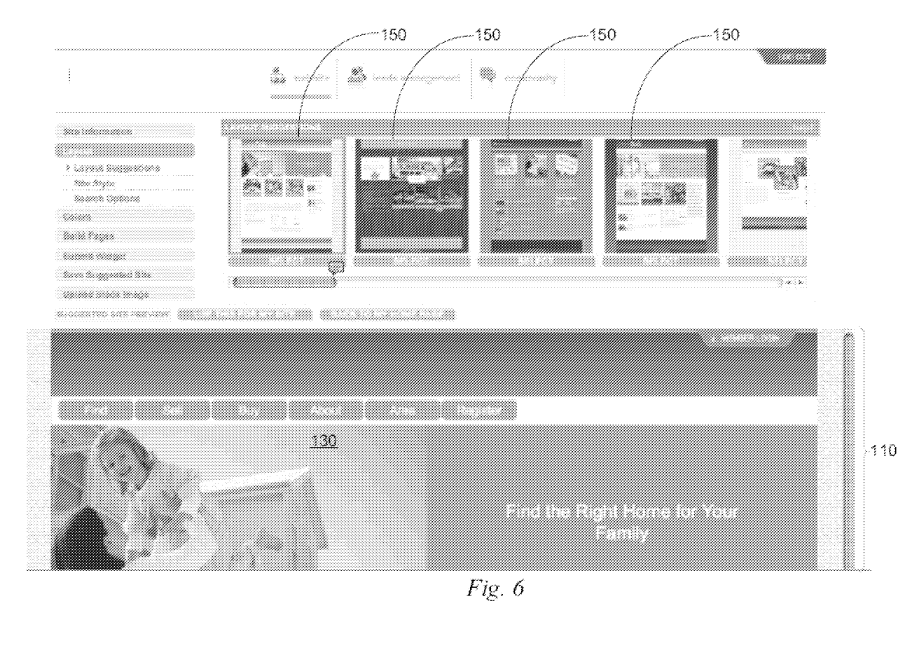

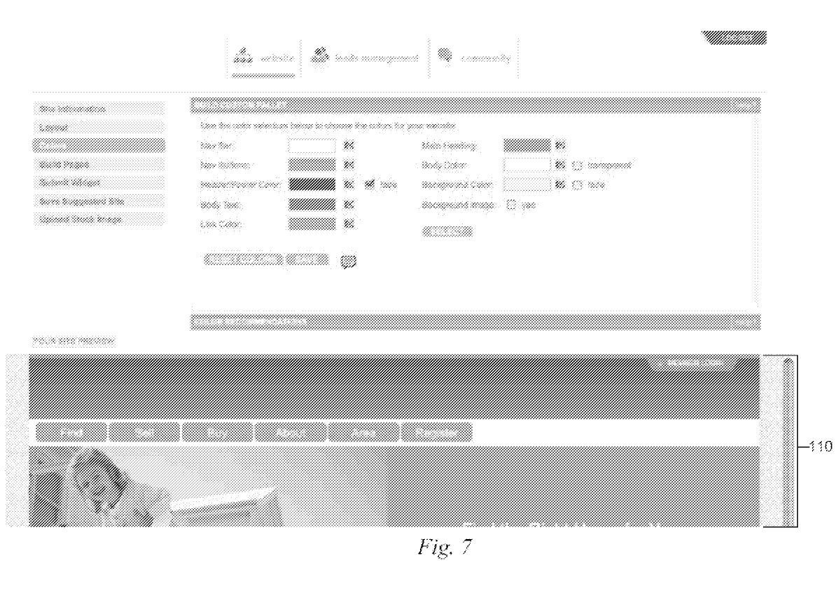

While the user can utilize the design interface in any suitable manner, FIG. 5 illustrates one non-limiting example of a method 500 for using the design interface. Specifically, at 505, FIG. 5 shows this method begins by having the user access the design interface via a web-browser. Next, at 510, the user enters a web site creation tool. Continuing at 515, the interface provides the user with several options. In one example, while the user can choose to start designing a webpage from scratch, FIG. 6 shows that, in at least some embodiments, the design interface provides the user with a selection of template webpages 150 in which specific widgets are already placed in the production environment 110. In another example, FIG. 7 shows the design interface allows the user to select a desired color scheme.

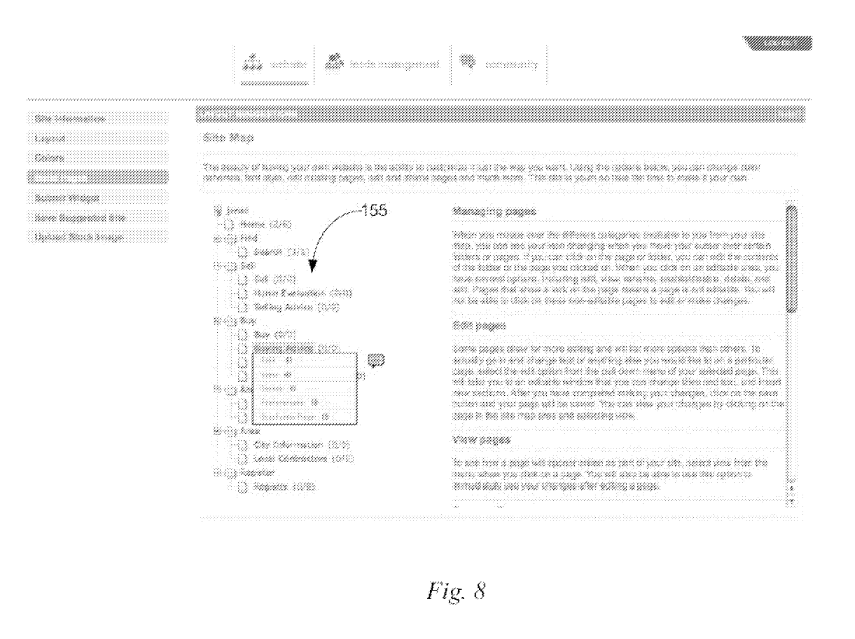

At 520, the method continues as the user enters a page build mode in which the interface displays a view of the webpage's site map. By way of illustration FIG. 8 shows a representative embodiment where the site map 155 is displayed in tree view. In the page build mode, the user can add or delete folders and webpages from the site map. Similarly, the user can change the pages position with respect to each other.

Next, at 525, the user enters the edit mode, where the user can design or edit a webpage by dragging and dropping widget icons and widgets, as described above. As the user makes changes to the webpage, FIG. 5 at 530 shows the design interface will automatically, and in near real time, update one or more of the webpage's definition files (e.g., CSS files, XML definition files, etc.).

Next, at 535, FIG. 5 shows the method continues as the interface optionally pushes the user's changes (e.g., the updated XML definitions) to the server. Then, at 540, the users is allowed to make additional changes. If the user chooses to make additional changes, FIG. 5 shows the method returns to box 530. However, if the user chooses not to make additional changes, FIG. 5 shows the method may terminate at 545.

As described above, the design interface may have several advantageous characteristics. In a first example, the design interface allows complete flexibility of placement and sizing of content (e.g., widget placing and sizing). In a second example, the interface allows the webpage under construction to be immediately active and available on the network, as the page is being built, without an extra user step of uploading or updating the webpage. In a third example, the interface allows content in the form of or contained in widgets to be overlapped and displayed with different levels of transparency, providing a rich environment for creative arrangement of content. In a fourth example, where the interface is network-based, no special software, besides a Web browser, need be installed on the user's computer. In a fifth example, the absolute positioning technique and automatic updating of the webpage's definition files enable the user who has little to no Web protocol or coding experience to design a webpage. In a sixth example, because the interface allows the user to place widgets that pull live content on the webpage and because the interface allows the user to redesign the webpage so quickly, the interface allows the user to update and keep the webpage fresh. In a seventh example, the interface allows the user to quickly design and replicate pages. In a final example, the interface allows virtually any form of content that can be displayed on the Internet to be integrated into a webpage, including content from other providers.

The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer program product for implementing within a computer system a method for designing a webpage, the computer program product comprising:
a computer readable medium for providing computer program code means utilized to implement the method, wherein the computer program code means is comprised of executable code for:
providing an interface for designing a webpage, wherein the interface comprises:
a first content widget; and
a production environment,
wherein the content widget is movable in the production environment through a drag-and-drop technique, and
wherein the interface automatically generates an updated webpage definition file when the first content widget is moved in the production environment.

2. The computer program product of claim 1, wherein the interface automatically pushes the updated webpage definition file to a server in near real time.

3. The computer program product of claim 2, wherein the interface automatically pushes the updated webpage definition file to the server through an asynchronous JavaScript and XML request.

4. The computer program product of claim 1, wherein the interface further comprises a second widget that is capable of being layered over the first widget through the drag-and-drop technique.

5. The computer program product of claim 1, wherein the interface comprises a snap-to-grid feature that automatically aligns the first content widget next to a nearby gridline when the first content widget is dropped in the drag-and-drop technique.

6. The computer program product of claim 1, wherein the interface creates the updated webpage definition file as a user edits the webpage and in near real time.

7. The computer program product of claim 1, wherein the interface comprises a widget locator that tracks a plurality of content widgets placed in the production environment.

8. A computer system for generating a webpage, the system comprising:
a computer processor; and
an interface for designing the webpage, wherein the interface comprises:
a first content widget; and
a production environment,
wherein the content widget is movable in the production environment through a drag-and-drop technique,
wherein the interface automatically generates an updated webpage definition file for the webpage when the first content widget is moved in the production environment, and
wherein the interface automatically pushes the updated webpage definition file to a server in near real time.

9. The system of claim 8, wherein the system is web-based.

10. The system of claim 8, wherein the interface creates the updated webpage definition file as a user edits the webpage and in near real time.

11. The system of claim 8, wherein the interface further comprises a second content widget that is capable of being layered over the first content widget through the drag-and-drop technique.

12. The system of claim 8, wherein the interface automatically pushes the updated webpage definition file to the server through an asynchronous JavaScript and XML request.

13. A method for designing a webpage, the method comprising:
using a system to perform a technique comprising:
providing an interface for designing the webpage, wherein the interface comprises:
a header section including a first widget icon; and
a production environment,
wherein:
the widget icon is movable from the header section to the production environment and becomes a first content widget in the production environment,
the first content widget is movable in the production environment through a drag-and-drop technique, and
the interface automatically generates an updated webpage definition file for the webpage when the first content widget is moved in the production environment; and
dragging and dropping the first content widget within the production environment.

14. The method of claim 13, wherein the interface automatically pushes the updated webpage definition file to a server in near real time.

15. The method of claim 13, wherein the interface automatically pushes the updated webpage definition file to the server through an asynchronous JavaScript and XML request.

16. The method of claim 13, wherein the interface further comprises a second content widget in the production environment that is capable of being layered over the first content widget through the drag-and-drop technique.

17. The method of claim 13, wherein the interface comprises a snap-to-grid feature that automatically aligns the first content widget next to a nearby gridline when the first content widget is dropped in the drag-and-drop technique.

18. The method of claim 13, wherein the interface creates the updated webpage definition file as a user edits the webpage and in near real time.

19. The method of claim 13, wherein the interface comprises a widget locator that tracks a plurality of content widgets placed in the production environment.

20. The method of claim 13, wherein the system is network-based.
